(19) United States
(12) Patent Application Publication
(10) Pub. No.: US 2026/0211725 A1
(43) Pub. Date: Jul. 23, 2026

(54) METHOD AND SYSTEM FOR SCHEDULE SYNCHRONIZATION IN A DISTRIBUTED SYSTEM

(71) Applicant: Telefonaktiebolaget LM Ericsson (publ), Stockholm (SE)

(72) Inventors: Fredrik SVENSSON, Löberöd (SE); Robert MARKLUND, Furulund (SE); Torgny HOLMBERG, Lund (SE)

(73) Assignee: Telefonaktiebolaget LM Ericsson (publ), Stockholm (SE)

(21) Appl. No.: 19/140,248

(22) PCT Filed: Dec. 20, 2022
(86) PCT No.: PCT/IB2022/062549

§ 371 Date: Jun. 17, 2025

(51) Int. Cl. G06F 9/48

(52) U.S. Cl. CPC G06F 9/4887

(57) ABSTRACT

Embodiments include methods, electronic device, storage medium, and computer program for schedule synchronization in a distributed system. In one embodiment, a method is to be implemented in a network node of a network and comprises: receiving a message indicating scheduling information of an application; when a scheduling scheme is feasible to deploy the application in the network, determining the scheduling scheme based on the scheduling information of the application, the scheduling scheme accommodating the application and constraints of one or more network nodes in the network; applying the scheduling scheme when the scheduling scheme is acceptable by one or more parties involved in deploying the application; and causing data of the application from the one or more parties to be processed in the network based on the scheduling scheme, wherein processing the data includes pre-fetching inform from the one or more parties prior to receiving the data of the application.

### TECHNICAL FIELD

Embodiments of the invention relate to the field of networking and more specifically, to schedule synchronization in a distributed system.

### BACKGROUND ART

Real-time systems are systems that carry real-time tasks (e.g., as a part of an application) with requirements on when in time a task needs to be finalized. Real-time does not necessarily imply low latencies, but rather low variance and high predictability. These tasks may be managed by a scheduler that determines the execution order of tasks such that the respective task can meet its latency requirements. Real-time applications can execute in a cloud environment and the applications are typically composed of several function blocks that can be distributed on multiple compute nodes requiring network communication between the functional blocks.

Yet current cloud execution solutions do not share and synchronize the information regarding the scheduling of tasks between the compute nodes and the network. In essence, the processing of tasks and the communication between tasks are separate procedures, and timely execution of real-time tasks can be negatively affected as a result. These existing solutions are reactive to the conditions of the compute nodes and the networks and are inefficient to comply with the latency requirements of real-time tasks.

### SUMMARY OF THE INVENTION

Embodiments include methods, electronic device, storage medium, and computer program for schedule synchronization in a distributed system. In one embodiment, a method is to be implemented in a network node of a network and comprises: receiving a message indicating scheduling information of an application; when a scheduling scheme is feasible to deploy the application in the network, determining the scheduling scheme based on the scheduling information of the application, the scheduling scheme accommodating the application and constraints of one or more network nodes in the network; applying the scheduling scheme when the scheduling scheme is acceptable by one or more parties involved in deploying the application; and causing data of the application from the one or more parties to be processed in the network based on the scheduling scheme, wherein processing the data includes pre-fetching inform from the one or more parties prior to receiving the data of the application.

In one embodiment, an electronic device comprises a processor and machine-readable storage medium that provides instructions that, when executed by the processor, are capable of causing the processor to perform operations of: receiving a message indicating scheduling information of an application; when a scheduling scheme is feasible to deploy the application in the network, determining the scheduling scheme based on the scheduling information of the application, the scheduling scheme accommodating the application and constraints of one or more network nodes in the network; applying the scheduling scheme when the scheduling scheme is acceptable by one or more parties involved in deploying the application; and causing data of the application from the one or more parties to be processed in the network based on the scheduling scheme, wherein processing the data includes pre-fetching inform from the one or more parties prior to receiving the data of the application.

In one embodiment, a machine-readable storage medium that provides instructions that, when executed by a processor, are capable of causing the processor to perform operations of: receiving a message indicating scheduling information of an application; when a scheduling scheme is feasible to deploy the application in the network, determining the scheduling scheme based on the scheduling information of the application, the scheduling scheme accommodating the application and constraints of one or more network nodes in the network; applying the scheduling scheme when the scheduling scheme is acceptable by one or more parties involved in deploying the application; and causing data of the application from the one or more parties to be processed in the network based on the scheduling scheme, wherein processing the data includes pre-fetching inform from the one or more parties prior to receiving the data of the application.

By sharing the scheduling information within a distributed system, embodiments of the invention may synchronize the scheduling in the distributed system and perform pre-processing in a network prior to the arrival of data of an application so that data processing in the distributed system may incur less latency, lower power consumption, greater quality of service (QoS), and/or other performance benefits over prior approaches where scheduling information is not shared.

### BRIEF DESCRIPTION OF THE DRAWINGS

The invention may best be understood by referring to the following description and accompanying drawings that are used to illustrate embodiments of the invention. In the drawings:

FIG. 1 illustrates an architecture for synchronized scheduling in a distributed network per some embodiments.

FIG. 2 illustrates an exemplary architecture for synchronized scheduling in a 5G distributed network per some embodiments.

FIG. 3 illustrates operations for synchronized scheduling in a 5G distributed network per some embodiments.

FIG. 4 is a flow diagram illustrating the operations to generate reinforcement models that provide resource allocation for service topologies with different dependencies per some embodiments.

FIG. 5 illustrates an electronic device implementing synchronized scheduling per some embodiments.

FIG. 6 illustrates an example of a communication system per some embodiments.

FIG. 7 illustrates a UE per some embodiments.

FIG. 8 illustrates a network node per some embodiments.

FIG. 9 is a block diagram of a host, which may be an embodiment of the host of FIG. 6, per various aspects described herein.

FIG. 10 is a block diagram illustrating a virtualization environment in which functions implemented by some embodiments may be virtualized.

FIG. 11 illustrates a communication diagram of a host communicating via a network node with a UE over a partially wireless connection per some embodiments.

### DETAILED DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

### Architecture for Synchronized Scheduling

A distributed system is a collection of compute nodes (an electronic device performing computation) connected over a network (wireless network and/or wireline network) that also include one or more compute nodes (also referred to as network nodes). Applications executing on the distributed system may be managed by schedulers on the compute nodes determining what tasks to execute and when. Applications are typically driven by periodic timers and/or external events such as receiving data (e.g., a packet) from the network. These events trigger interrupts that invoke the scheduler, and it determines when to execute the tasks. Note that while the term of “packet” is used to exemplify data generated to perform a task for an application/service provided to a client, other formats of data (e.g., data frames or other types of packet data units) are equally applicable and may be used in some embodiments of the inventions.

The execution of a task may be based on a scheduling policy. A scheduling policy is the framework that drives resource allocation at a compute node, and it may indicate one or more rules to determine fairness of resource allocation (round-robin, deadline driven, task consuming the least/most resources first, etc.). A scheduling scheme indicates prioritization/execution sequence of specific tasks at a compute node and may be derived based on the scheduling policy and the specifics of the compute node and the tasks to be executed. For example, based on the available resources on the compute node and the scheduling policy being deadline driven, a task that's due first is scheduled to be executed first in the scheduling scheme to fulfill the scheduling policy.

The network may also have its own scheduling mechanism and policies, such as determining what order to handle queued packets. When the network handles a packet, it can include tasks (e.g., looking up routing information, billing information, etc.) that consume time. These tasks may be executed in the network ahead of the packet arrival, if the network is aware of the schedules of the compute node that transmits the packet.

Embodiments of the invention propagate the task scheduling information through the network so that the network (and other compute nodes) may prepare and perform preprocessing accordingly. For example, the network may use the task scheduling information to prefetch required information needed to handle the packet, and/or to set up the required resources ahead of time to decrease latency and make the latency more predictable.

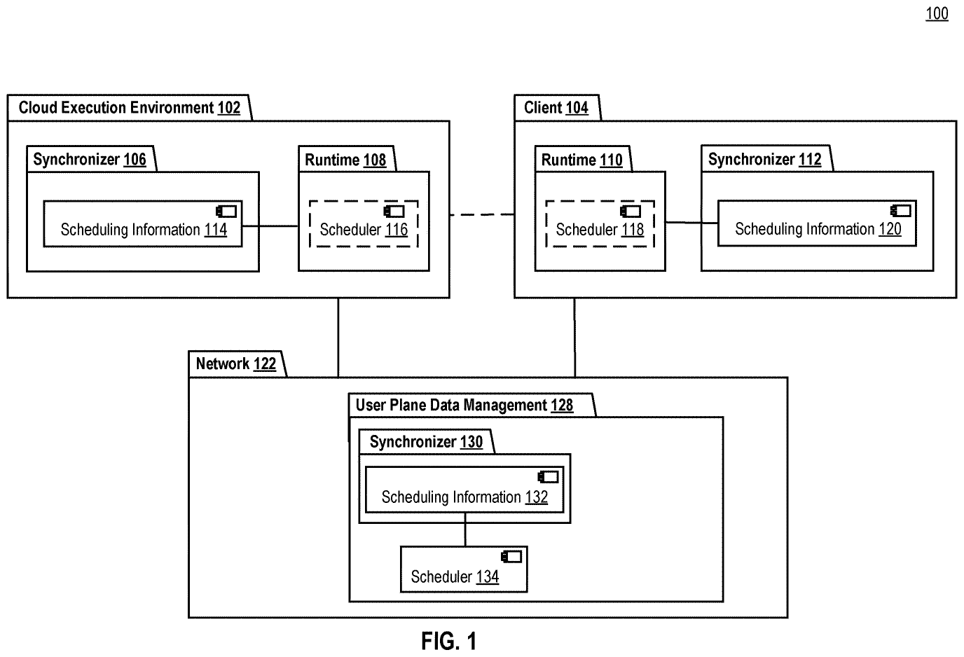

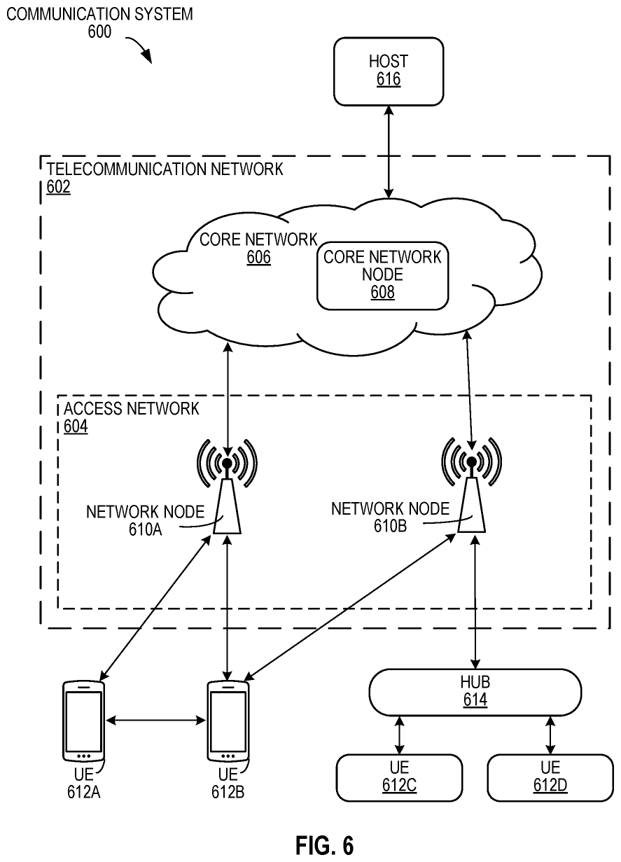

FIG. 1 illustrates an architecture for synchronized scheduling in a distributed network per some embodiments. System 100 includes a cloud execution environment 102 and a client 104, and the communication between the two entities is through a network 122. In some embodiments, cloud execution environment 102 and client 104 may communicate directly without going through network 122. Network 122 may include a wireless network and/or a wireline network. In some embodiments, network 122 includes the wireless network discussed relating to FIG. 6.

Client 104 is to access one or more cloud services provided by the cloud execution environment 102 (e.g., through network 122). Client 104 may be implemented in an electronic device (e.g., a compute node such as one of user equipment (UE) 612A-612D in FIG. 6). The cloud execution environment 102 provides cloud services to clients such as client 104, and it may be implemented in one or more electronic devices (e.g., each may be a compute node such as host 616 in FIG. 6) in some embodiments.

In system 100, either client 104 or cloud execution environment 102 may provide scheduling information about the tasks for providing an application to client 104 through network 122. Network 122 can utilize this scheduling information to optimize its performance with given constraints, and the optimization includes to reduce application performance/response time, minimize missed task deadlines, and/or minimize power usage/maximize power save at one or more compute nodes.

Each of cloud execution environment 102, client 104, and network 122 may implement a synchronizer for schedule synchronization in some embodiments. Such synchronizer may be implemented as a hardware/software module in an electronic device. As shown, the synchronizers for cloud execution environment 102, client 104, and network 122 are synchronizers 106, 112, and 130, respectively.

### Synchronizers of Cloud Execution Environment and Client

In some embodiments, synchronizers 106 and 112 derive scheduling information 114 and 120 about tasks to be executed in their respective runtimes 108 and 110, respectively. A runtime is an execution environment that provides the functionality for an application/service to run and may include an operating system, a virtual machine, a container, or other processing resources in some embodiments.

In some embodiments, a runtime includes a scheduler to determine a scheduling scheme (e.g., the execution order of tasks to be performed) in the runtime, e.g., schedulers 116 and 118 within runtimes 108 and 110, respectively. The scheduling scheme may be based on a scheduling policy as discussed herein. The corresponding synchronizer may obtain the scheduling information from the scheduler.

For example, for a task running with a schedule (e.g., the SCHED_DEADLINE Linux CPU scheduler), the runtime may share the task parameters with the respective synchronizer. For an application, the schedule of a task in an embodiment may define parameters of how the task should be scheduled, including the following: (1) execution time, (2) period, and (3) deadline. These parameters state that the task should receive one or more durations of execution time (e.g., each being n microseconds) in every period (e.g., m microseconds where m≥n), and these durations in the period are available within a deadline (e.g., o microseconds where o≥m≥n) from the beginning of the period. In some embodiments, a priority indication is included to indicate the relative priority of the task. The network can utilize this information to setup one or more scheduling policies to be prepared for data being sent for the application.

For tasks that are driven by periodic timers (e.g., the periodic timers coupled with or included within a scheduler), the runtime may share the timer information with the corresponding synchronizer.

In other embodiments, a runtime does not use a scheduler to determine the execution order of tasks, at least not for some applications. In that case, the synchronizer may derive scheduling information itself based on task execution in the runtime.

For example, for tasks that are not periodic (e.g., data driven tasks), the runtime may use techniques such as pattern recognition to learn the execution pattern and how it produces data that is to be sent over the network. This information is shared to the synchronizer and based on this information, the synchronizer may create a timetable that states when the application will send data to the network.

The pattern recognition may be performed through machine learning, which identifies one or more task patterns using one or more machine learning models. The machine learning models may use supervised learning, unsupervised learning, semi-supervised learning, or other types of learning. It can use artificial neural networks, decision trees, support-vector machines, regression analysis, Bayesian networks, genetic algorithms, or any other framework. The machine learning models may be trained based on known task patterns for particular applications with the aim of optimizing task execution efficiency—e.g., minimizing resources used for executing the tasks and/or fastest task execution for the application.

The scheduling information corresponding to the tasks, including one or more timetables may then be published by cloud execution environment 102 and client 104 to other parts of system 100. For example, the scheduling information 114 of cloud execution environment 102 may be provided to network 122 and client 104, and the scheduling information 120 of client 104 may be provided to network 122 and cloud execution environment 102.

Additionally, cloud execution environment 102 and client 104 handle responses for the sent scheduling information. A response can be that all requirements can be met or that some or all requirements could not be met. For the latter, remedial actions may be taken, for example, adjusting the packet rate; or, when a higher-level intervention is required, triggering an error that the application or the function orchestrating the application can respond to.

### Synchronizer of Network

As shown, network 122 includes synchronizer 130 that coordinates with synchronizers 106 and 112. Synchronizer 130 and a scheduler 134 that schedules task execution in network 122 may be implemented within or coupled with a compute node that includes a user plane data management module 128. The compute node may be one of core network node 608 and network nodes 610A-610B in FIG. 6 in some embodiments. User plane data management module 128 coordinates user plane data processing, e.g., managing resources to route and forward packets according to the requirements from scheduling schemes. In a Fifth Generation (5G) system, user plane data management module 128 may be implemented as a user plane function (UPF); in a Fourth Generation (4G) system, user plane data management module 128 may be implemented as one or more of serving gateway (SGW) and packet data network gateway (PGW).

Synchronizer 130 receives scheduling information from cloud execution environment 102 and client 104 (e.g., through synchronizers 106 and 112), and provides the received scheduling information and existing scheduling information 132 for existing tasks within network 122 to scheduler 134. Scheduler 134 in turn coordinates task performance within network 122 to optimize data process performance in network 122.

For example, based on the scheduling information, scheduler 134 may cause user plane data management module 128 to do one or more of the following preprocessing to prepare for data arrival for the corresponding application: (1) storing data in a higher priority to avoid cache evictions of data within important and frequent sessions; (2) setting up triggers to be executed ahead of a packet arrival to be able to pre-allocate buffers and to prefetch information needed to handle the packet; (3) causing one or more compute nodes or modules within compute nodes to enter power save states if there will be long periods without data transmission, based on the scheduling information; and (4) mimicking the scheduling policies of cloud execution environment 102 and/or client 104 as indicated in the scheduling information so that the consistent data processing is performed (e.g., if data for application A is processed ahead of data for application B in client 104, the same prioritization is followed in network 122).

Based on the received scheduling information, scheduler 134 may determine whether or not the required schedule may be met with resource constraints (e.g., one or more computing, bandwidth, and/or storage resource constraints) within network 122. Scheduler 134 may then return a response stating if scheduling requests based on the received scheduling information can or cannot be implemented.

With scheduler 134 forming a scheduling scheme for data processing in network 122 based on the scheduling information received from cloud execution environment 102 and/or client 104, system 100 may synchronize data processing in the distributed system and provide more efficient resource usage. Scheduler 134 may allocate resources in network 122 to process data, prior to the arrival of the data of a corresponding application, for providing the application by cloud execution environment 102 to client 104 and reduce (1) latency in providing the service/application and/or (2) power consumption for providing the service/application (e.g., reducing resources involved by moving nodes/modules into power save states), increase quality of service (QoS) provided by network 122, and/or otherwise improve the efficiency of network 122 to schedule tasks for the service/application.

### Synchronized Scheduling in Exemplary Architecture Embodiments

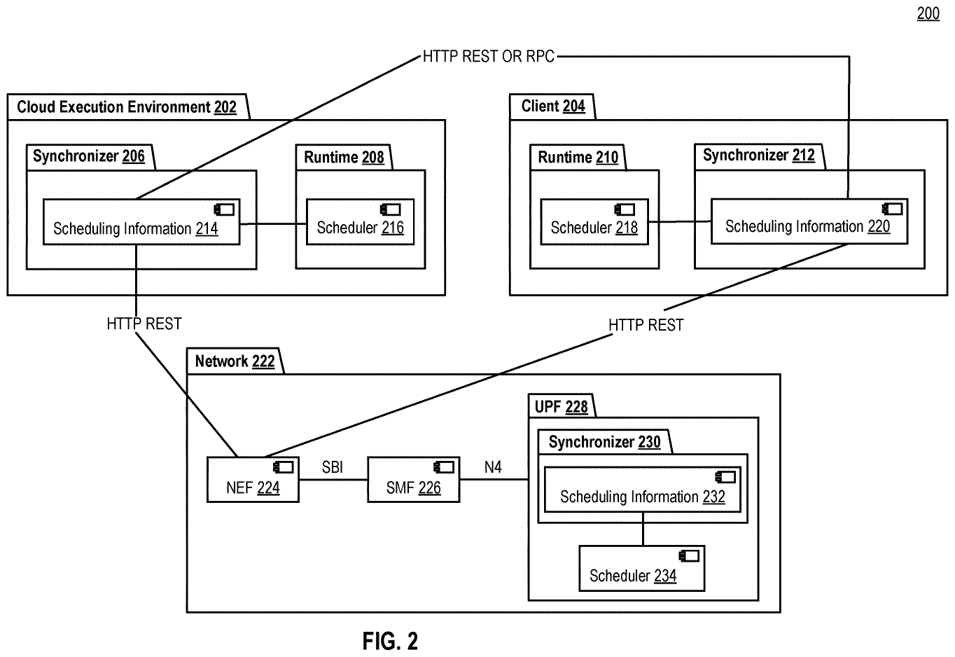

The architecture shown in system 100 may be implemented differently for different distributed systems. For example, specific communication protocols, application programming interfaces (APIs), and/or applications/services may cause embodiments of the invention to be implemented differently and still provide synchronized scheduling in these distributed systems. FIG. 2 illustrates an exemplary architecture for synchronized scheduling in a 5G distributed network per some embodiments. System 200 is a 5G system with specific 5G system entities, and it is similar to system 100 in FIG. 1 and the similar references indicate elements or components having the same or similar functionalities.

In FIG. 2, hypertext transfer protocol (HTTP) Representational state transfer (REST) APIs are the communication interfaces (1) between cloud execution environment 202 and network 222, and (2) between client 204 and network 222 for the synchronized scheduling. REST APIs may be used by entities to interact with each other via GET, POST, PUT, or DELETE operations. The HTTP REST APIs and/or remote procedure calls (RPCs) may be the communication interfaces between cloud execution environment 202 and client 204. RPCs may be used by entities to interact with each other with GET and POST. Both REST APIs and RPCs may be used effectively to exchange scheduling information between the entities.

In network 222, user plane function (UPF) 228 manages user plane data and coordinate the synchronized scheduling in network 222 with cloud execution environment 202 and client 204. To interact with UPF 228, the HTTP REST APIs communicates with a network exposure function (NEF) 224. NEF 224 exposes services and resources over the APIs within and outside of the 5G system. NEF 224 interacts with a session management function (SMF) 226, which performs operations like session management, IP address allocation & management for client 204, user plane selection, QoS and policy enforcement for the control plane, and SMF 226 may be used for service registration/discovery/establishment. NEF 224 interacts with SMF 226 through a service-based interface (SBI) in some embodiments. SMF 226 interacts with UPF 228 for the sharing of scheduling information through a N4 interface in some embodiments.

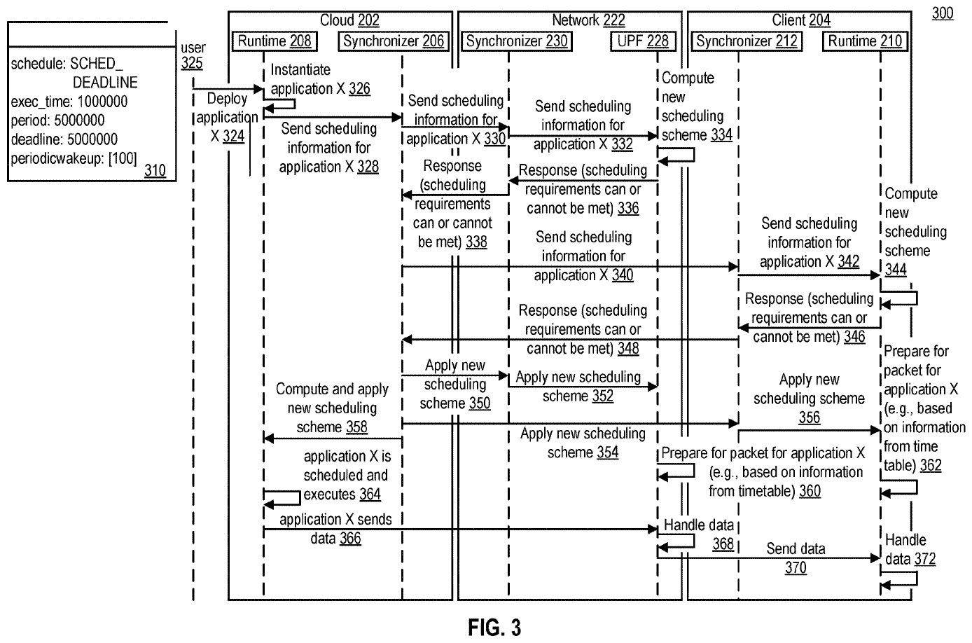

FIG. 3 illustrates operations for synchronized scheduling in a 5G distributed network per some embodiments. The 5G distributed network is the one shown in FIG. 2 and the same cloud execution environment 202, network 222, and client 204 are shown with the corresponding entities implemented within (or to be coupled with) them. Flow 300 shows operations involved to perform schedule synchronization in the distributed system 200 to accommodate an application.

A user 325 requests to deploy an application X at reference 324. In one embodiment, the task to run for application X is requested with a schedule 310, which may be specified through the SCHED_DEADLINE Linux CPU scheduler. Schedule 310 includes (1) an execution time of 1,000,000 microseconds, (2) a period of 5,000,000 microseconds, and (3) a deadline of 5,000,000 microseconds. Additionally, the task to be periodically wake up at 100 microseconds after completion of a prior execution (within the 100 microseconds, the task does not take any resources).

Cloud execution environment 202 initiates application X in its runtime 208 at reference 326, and the scheduling information for application X is sent to synchronizer 206 of cloud execution environment 202 at reference 328. Synchronizer 206 in turn provides the scheduling information for application X to synchronizer 230 of network 222 at reference 330 (e.g., through NEF 224 and SMF 226).

UPF 228 receives the scheduling information for application X at reference 332, and it computes a new scheduling scheme (referred to as scheme N for network) for application X at reference 334 when feasible. The scheduling scheme at network 222 is computed based on the received scheduling information and one or more constraints of the network node. The constraints may include one or more computing, bandwidth, storage resource constraints at one or more compute nodes within network 222 (e.g., core network node 608 and network nodes 610A-610B in FIG. 6). Regardless of whether the scheduling scheme may be generated at network 222, a response is returned to synchronizer 230 at reference 336, indicating whether the scheduling scheme can be generated. The response is then relayed to synchronizer 206 at reference 338.

At reference 340, the scheduling information for application X may be sent to synchronizer 212 of client 204 in parallel with sending to synchronizer 230 of network 222, or in sequence (prior to or after) of sending to synchronizer 230 of network 222. Synchronizer 212 sends the scheduling information for application X to runtime 210 of client 204 at reference 342. The runtime computes a new scheduling scheme (referred to as scheme Ct for client) for application X at reference 344 when feasible. The scheduling scheme at client 204 is computed based on the received scheduling information and one or more constraints of client 204. Similar to the constraints relating to network 222, the constraints may include one or more computing, bandwidth, storage resource constraints at one or more compute nodes implementing client 204 (e.g., UE 612A to 612D in FIG. 6). Regardless of whether the scheduling scheme at client 204 may be generated, a response is returned to synchronizer 212 at reference 346, indicating whether the scheduling scheme can be generated. The response is then relayed to synchronizer 206 at reference 348.

At reference 350, synchronizer 206 of cloud execution environment 202 indicates its consent to the scheduling scheme generated by UPF 228 to synchronizer 230 of network 222 at reference 350, and synchronizer 230 relays the consent to UPF 228 at reference 352. UPF 228 may then apply the scheduling scheme. The consent may be sent as a response message to the message at reference 338.

Similarly, at reference 354, synchronizer 206 of cloud execution environment 202 indicates its consent to the scheduling scheme generated by runtime 210 of client 204 to synchronizer 212 of client 204 at reference 350, and synchronizer 212 relays the consent to runtime 210 at reference 356. Runtime 210 may then apply the scheduling scheme.

At references 360 and 362, the UPF 228 and runtime 210 prepare for packet arrival for application X using the applied scheduling schemes (schemes N and Ct). For example, the scheduling schemes may include timetables indicating when the packets are supposed to arrive and pre-allocate buffers and prefetch information needed to handle the packet.

At cloud execution environment 202, once the responses from network 222 and client 204 are returned indicating that they may generate feasible scheduling schemes, synchronizer 206 requests runtime 208 to generate and apply a new scheduling scheme (referred to as scheme Cd for cloud) for application X when feasible at reference 358. Runtime 208 then schedules and executes application X based on the new scheduling scheme at reference 364. The execution will cause application X to send data (in packets) to send to network 222, where UPF 228 will coordinate the handling of the data at reference 368. Network 222 will generate further data for application X, and the data is sent to client 204 at reference 370, and runtime 210 at reference 372 will handle the data at reference 372. The data handling will be more efficient since the scheduling schemes at cloud execution environment 202, network 222, and client 204 are synchronized.

Note that scheduling schemes N, Ct, and Cd, while being synchronized, are not necessarily identical because each of network 222, client 204, and cloud execution environment 202 have to accommodate their respective resource constraints and thus perform different operations to synchronize scheduling of data processing. Additionally, while flow 300 shows that feasible scheduling schemes N, Ct, and Cd are generated for application X, sometimes no feasible scheme may be generated at one or more of cloud execution environment 202, network 222, and client 204. The application X may be executed with a different schedule in that case. For example, the packet rate for application X may be reduced. Additionally/alternatively, an error may be triggered for the application or the function orchestrating the application to respond—e.g., a set of remedial operations may be triggered to alleviate issues at one or more of cloud execution environment 202, network 222, and/or client 204 so an optimal synchronized schedule may be implemented in the distributed system. In some embodiments, scheduling schemes N, Ct, and Cd are derived by the compute nodes based on the same scheduling policy.

While FIG. 3 shows that the request to deploy an application is initiated from a cloud execution environment, alternative embodiments may have the request to deploy an application from a client or a node within the network. Embodiments of the invention are not limited to the specifics of where and how an application deployment is initiated.

An exemplary application for application X is periodic temperature read. The application reads temperature every 100 milliseconds and publishes the read values to a Message Queue (MQ) Telemetry Transport (MQTT) server. The schedule of such thermometer application may be indicated as the following three lines of pseudo code:

thermometer : sensor.Temperature(period=100)
mqtt : net.MQTTPublisher(hostname=“broker.hivemq.com”, port=1883)
thermometer.centigrade > mqtt.topic

The schedule describes an application based on the actor model using data flow for connecting the actors and their in-ports and out-ports. The first line states an actor used to read a temperature with a period of 100 milliseconds. The second line states a second actor used to publish data to a MQTT server with the hostname broker.hivemq.com and through port 1883. In the third line the symbol “>” is used to connect the two actor and their out- and in-port named centigrade and topic, indicating data should go from thermometer.centigrade to mqtt.topic.

When the application is deployed in a cloud execution environment 202, runtime 208 will schedule the application every 100 milliseconds, triggering the application to read the temperature and send data to an MQTT server. The synchronizer 206 of the cloud execution environment 202 extracts this scheduling information from runtime 208 and creates a data structure that is sent to NEF 224. The data format can be in JavaScript Object Notation (JSON) and look like this:

{
“temp.calvin”: {“priority”: 1, “tx_periods”: [{“time”: 100, “size”: 40}]},

The priority states the application priority and the size in tx_periods is an approximation of how much data that will be sent, both are optional and set when the application is deployed. These are examples of parameters that can be included to optimize the packet handling in the network.

Based on this scheduling information, synchronizer 230 may schedule UPF 228 to wake up every 100 milliseconds and to be ready to handle the data sent from the application. This can include prefetching data for that session such as routing and billing information and pre-allocating required buffers.

If this scheduling information can't be extracted when the application is deployed, runtime 208 can record how the application is executed and produces data to find patterns; and when patterns are found, synchronizer 206 publishes the scheduling information to network 222 and/or client 204.

### Operations Per Some Embodiments

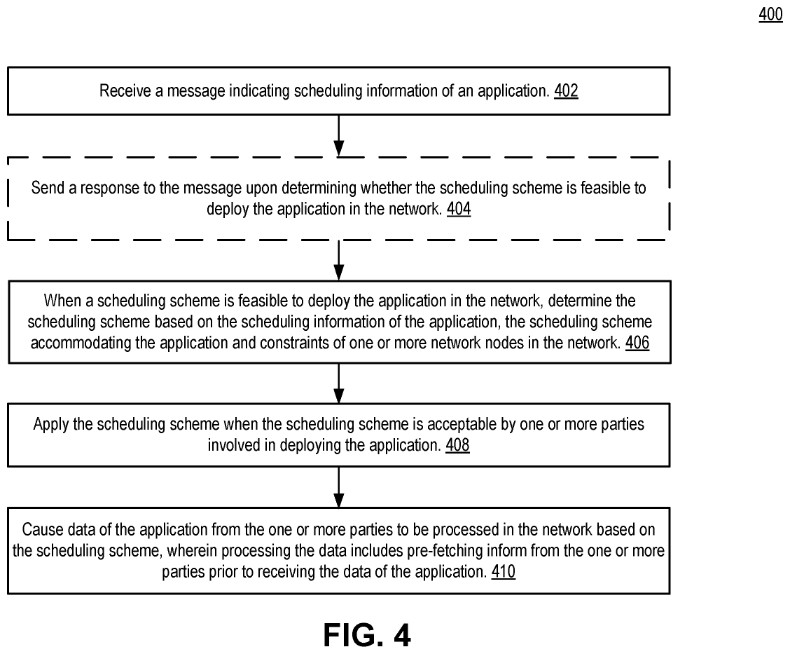

FIG. 4 is a flow diagram illustrating the operations to synchronize scheduling in a distributed network per some embodiments. The operations may be performed by a network node that manages user plane data, e.g., the one implementing user plane data management module 128 or UPF 228.

At reference 402, a message indicating scheduling information of an application is received. Optionally at reference 404, a response is sent upon determining whether the scheduling scheme is feasible to deploy the application in the network; and at reference 406, a scheduling scheme is determined based on the scheduling information of the application, when a scheduling scheme is feasible to deploy the application in the network, the scheduling scheme accommodating the application and constraints of one or more network nodes in the network. The network nodes include ones involved in deploying the application in the network, and the constraints include limitations on the network nodes' computing, bandwidth, storage resources.

At reference 408, the scheduling scheme is applied when the scheduling scheme is acceptable by one or more parties involved in deploying the application. The one or more parties includes, e.g., the client for which the application is deployed (e.g., client 104 or 204) and the cloud execution environment that provides the application (e.g., cloud execution environment 102 or 202). At reference 410, the electronic device causes data of the application from the one or more parties to be processed in the network based on the scheduling scheme, where processing the data includes pre-fetching inform from the one or more parties prior to receiving the data of the application.

In some embodiments, the scheduling information of the application is derived from scheduling parameters of the application, wherein the scheduling parameters indicate one or more of: how long one or more tasks of the application are to be ran in one instance, a periodic duration in which the one or more tasks of the application are to be ran, a deadline of executing the one or more tasks of the application, and priority of the one or more tasks. These parameters of a schedule have been discussed herein above.

In some embodiments, the scheduling information of the application is provided by a periodic timer when one or more corresponding tasks of the application are driven by a timer. In some embodiments, the scheduling information of the application is derived based a pattern of the data of the application at the one or more parties involved in deploying the application.

In some embodiments, the scheduling information of the application specifies when the application sends data to the network node. For example, the scheduling information may include a timetable discussed herein above.

In some embodiments, when no scheduling scheme is feasible to deploy the application in the network, the response indicates one or more requirements of the application that the network cannot meet. For example, the response indicates the required task duration may be shorter than what can be accommodated. In that, the requesting party may reduce the packet rate thus resulting in a longer task duration. The requesting party may revise the scheduling information indicating the longer task duration, which the network may be able to accommodate.

In some embodiments, the scheduling scheme is deemed to be acceptable by one or more parties involved in deploying the application when a confirmation is received from the one or more parties about the scheduling scheme. In some embodiments, the one or more parties transmits the confirmation upon the one or more parties receiving the scheduling scheme from the network node. The confirmation may be the consent message at references 350 and 354 discussed herein above.

In some embodiments, applying the scheduling scheme comprises setting up one or more triggers to allocation resources prior to getting the data of the application from the one or more parties. In some embodiments, applying the scheduling scheme comprises reducing power consumption of the network node prior to getting the data from the one or more parties.

In some embodiments, processing data from the one or more parties based on the scheduling scheme comprises maintaining data from the one or more parties in a cache when the scheduling information of the application indicates that occurrence of the application is over a threshold. When the occurrence of the application is over the threshold, data of the application are avoided from being evicted from a cache and resulting in faster execution of the application in the network.

In some embodiments, a user plane function (UPF) of the network function determines the scheduling scheme based on the scheduling information of the application. In some embodiments, the message indicating scheduling information of the application is received by the UPF through a network exposure function (NEF) and a session management function (SMF), as shown in FIG. 2.

### Devices Implementing Embodiments of the Invention

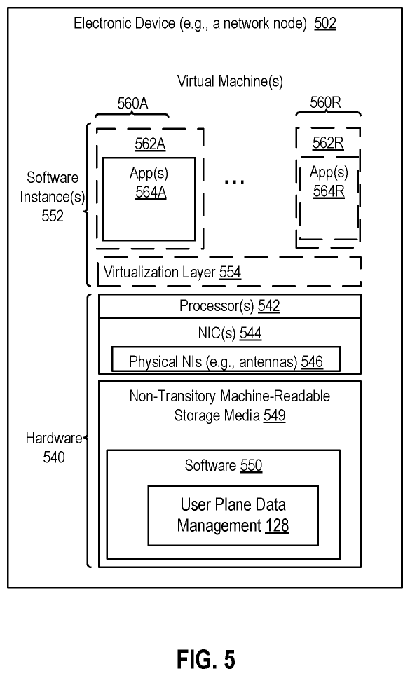

FIG. 5 illustrates an electronic device implementing synchronized scheduling per some embodiments. The electronic device may be or a network node in a wireless/wireline network. The electronic device 502 may be implemented using custom application-specific integrated-circuits (ASICs) as processors and a special-purpose operating system (OS), or common off-the-shelf (COTS) processors and a standard OS. In some embodiments, the electronic device 502 implements user plane data management module 128.

The electronic device 502 includes hardware 540 comprising a set of one or more processors 542 (which are typically COTS processors or processor cores or ASICs) and physical NIs 546, as well as non-transitory machine-readable storage media 549 having stored therein software 550. During operation, the one or more processors 542 may execute the software 550 to instantiate one or more sets of one or more applications 564A-R. While one embodiment does not implement virtualization, alternative embodiments may use different forms of virtualization. For example, in one such alternative embodiment, the virtualization layer 554 represents the kernel of an operating system (or a shim executing on a base operating system) that allows for the creation of multiple instances 562A-R called software containers that may each be used to execute one (or more) of the sets of applications 564A-R. The multiple software containers (also called virtualization engines, virtual private servers, or jails) are user spaces (typically a virtual memory space) that are separate from each other and separate from the kernel space in which the operating system is run. The set of applications running in a given user space, unless explicitly allowed, cannot access the memory of the other processes. In another such alternative embodiment, the virtualization layer 554 represents a hypervisor (sometimes referred to as a virtual machine monitor (VMM)) or a hypervisor executing on top of a host operating system, and each of the sets of applications 564A-R run on top of a guest operating system within an instance 562A-R called a virtual machine (which may in some cases be considered a tightly isolated form of software container) that run on top of the hypervisor—the guest operating system and application may not know that they are running on a virtual machine as opposed to running on a “bare metal” host electronic device, or through para-virtualization the operating system and/or application may be aware of the presence of virtualization for optimization purposes. In yet other alternative embodiments, one, some, or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 540, directly on a hypervisor (in which case the unikernel is sometimes described as running within a LibOS virtual machine), or in a software container, embodiments can be implemented fully with unikernels running directly on a hypervisor represented by virtualization layer 554, unikernels running within software containers represented by instances 562A-R, or as a combination of unikernels and the above-described techniques (e.g., unikernels and virtual machines both run directly on a hypervisor, unikernels, and sets of applications that are run in different software containers).

The software 550 contains user plane data management module 128 that performs synchronized scheduling as discussed relating to FIGS. 1 to 4. user plane data management module 128 may be instantiated within the applications 564A-R. The instantiation of the one or more sets of one or more applications 564A-R, as well as virtualization if implemented, are collectively referred to as software instance(s) 552. Each set of applications 564A-R, corresponding virtualization construct (e.g., instance 562A-R) if implemented, and that part of the hardware 540 that executes them (be it hardware dedicated to that execution and/or time slices of hardware temporally shared), forms a separate virtual electronic device 560A-R.

A network interface (NI) may be physical or virtual. In the context of IP, an interface address is an IP address assigned to an NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). The NI is shown as network interface card (NIC) 544. The physical network interface 546 may include one or more antenna of the electronic device 502. An antenna port may or may not correspond to a physical antenna. The antenna comprises one or more radio interfaces.

### a Wireless Network Per Some Embodiments

FIG. 6 illustrates an example of a communication system 600 per some embodiments.

In the example, the communication system 600 includes a telecommunication network 602 that includes an access network 604, such as a radio access network (RAN), and a core network 606, which includes one or more core network nodes 608. The access network 604 includes one or more access network nodes, such as network nodes 610a and 610b (one or more of which may be generally referred to as network nodes 610), or any other similar 3^{rd} Generation Partnership Project (3GPP) access node or non-3GPP access point. The network nodes 610 facilitate direct or indirect connection of user equipment (UE), such as by connecting UEs 612a, 612b, 612c, and 612d (one or more of which may be generally referred to as UEs 612) to the core network 606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 600 may include any number of wired or wireless networks, network nodes, UEs, and/or any other components or systems that may facilitate or participate in the communication of data and/or signals whether via wired or wireless connections. The communication system 600 may include and/or interface with any type of communication, telecommunication, data, cellular, radio network, and/or other similar type of system.

The UEs 612 may be any of a wide variety of communication devices, including wireless devices arranged, configured, and/or operable to communicate wirelessly with the network nodes 610 and other communication devices. Similarly, the network nodes 610 are arranged, capable, configured, and/or operable to communicate directly or indirectly with the UEs 612 and/or with other network nodes or equipment in the telecommunication network 602 to enable and/or provide network access, such as wireless network access, and/or to perform other functions, such as administration in the telecommunication network 602.

In the depicted example, the core network 606 connects the network nodes 610 to one or more hosts, such as host 616. These connections may be direct or indirect via one or more intermediary networks or devices. In other examples, network nodes may be directly coupled to hosts. The core network 606 includes one more core network nodes (e.g., core network node 608) that are structured with hardware and software components. Features of these components may be substantially similar to those described with respect to the UEs, network nodes, and/or hosts, such that the descriptions thereof are generally applicable to the corresponding components of the core network node 608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 616 may be under the ownership or control of a service provider other than an operator or provider of the access network 604 and/or the telecommunication network 602, and may be operated by the service provider or on behalf of the service provider. The host 616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 600 of FIG. 6 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 602 is a cellular network that implements 3GPP standardized features. Accordingly, the telecommunications network 602 may support network slicing to provide different logical networks to different devices that are connected to the telecommunication network 602. For example, the telecommunications network 602 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 612 are configured to transmit and/or receive information without direct human interaction. For instance, a UE may be designed to transmit information to the access network 604 on a predetermined schedule, when triggered by an internal or external event, or in response to requests from the access network 604. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 614 communicates with the access network 604 to facilitate indirect communication between one or more UEs (e.g., UE 612c and/or 612d) and network nodes (e.g., network node 610b). In some examples, the hub 614 may be a controller, router, content source and analytics, or any of the other communication devices described herein regarding UEs. For example, the hub 614 may be a broadband router enabling access to the core network 606 for the UEs. As another example, the hub 614 may be a controller that sends commands or instructions to one or more actuators in the UEs. Commands or instructions may be received from the UEs, network nodes 610, or by executable code, script, process, or other instructions in the hub 614. As another example, the hub 614 may be a data collector that acts as temporary storage for UE data and, in some embodiments, may perform analysis or other processing of the data. As another example, the hub 614 may be a content source. For example, for a UE that is a VR headset, display, loudspeaker or other media delivery device, the hub 614 may retrieve VR assets, video, audio, or other media or data related to sensory information via a network node, which the hub 614 then provides to the UE either directly, after performing local processing, and/or after adding additional local content. In still another example, the hub 614 acts as a proxy server or orchestrator for the UEs, in particular in if one or more of the UEs are low energy IoT devices.

The hub 614 may have a constant/persistent or intermittent connection to the network node 610b. The hub 614 may also allow for a different communication scheme and/or schedule between the hub 614 and UEs (e.g., UE 612c and/or 612d), and between the hub 614 and the core network 606. In other examples, the hub 614 is connected to the core network 606 and/or one or more UEs via a wired connection. Moreover, the hub 614 may be configured to connect to an M2M service provider over the access network 604 and/or to another UE over a direct connection. In some scenarios, UEs may establish a wireless connection with the network nodes 610 while still connected via the hub 614 via a wired or wireless connection. In some embodiments, the hub 614 may be a dedicated hub—that is, a hub whose primary function is to route communications to/from the UEs from/to the network node 610b. In other embodiments, the hub 614 may be a non-dedicated hub—that is, a device which is capable of operating to route communications between the UEs and network node 610b, but which is additionally capable of operating as a communication start and/or end point for certain data channels.

### UE Per Some Embodiments

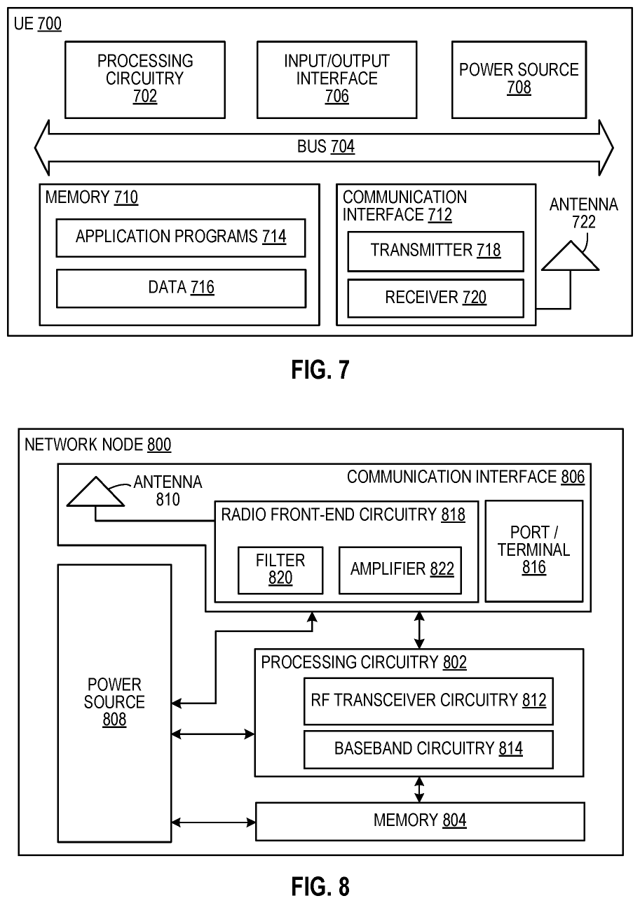

FIG. 7 illustrates a UE 700 per some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 700 includes processing circuitry 702 that is operatively coupled via a bus 704 to an input/output interface 706, a power source 708, a memory 710, a communication interface 712, and/or any other component, or any combination thereof. Certain UEs may utilize all or a subset of the components shown in FIG. 7. The level of integration between the components may vary from one UE to another UE. Further, certain UEs may contain multiple instances of a component, such as multiple processors, memories, transceivers, transmitters, receivers, etc.

The processing circuitry 702 is configured to process instructions and data and may be configured to implement any sequential state machine operative to execute instructions stored as machine-readable computer programs in the memory 710. The processing circuitry 702 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 702 may include multiple central processing units (CPUs).

In the example, the input/output interface 706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 708 is structured as a battery or battery pack. Other types of power sources, such as an external power source (e.g., an electricity outlet), photovoltaic device, or power cell, may be used. The power source 708 may further include power circuitry for delivering power from the power source 708 itself, and/or an external power source, to the various parts of the UE 700 via input circuitry or an interface such as an electrical power cable. Delivering power may be, for example, for charging of the power source 708. Power circuitry may perform any formatting, converting, or other modification to the power from the power source 708 to make the power suitable for the respective components of the UE 700 to which power is supplied.

The memory 710 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 710 includes one or more application programs 714, such as an operating system, web browser application, a widget, gadget engine, or other application, and corresponding data 716. The memory 710 may store, for use by the UE 700, any of a variety of various operating systems or combinations of operating systems.

The memory 710 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 710 may allow the UE 700 to access instructions, application programs and the like, stored on transitory or non-transitory memory media, to off-load data, or to upload data. An article of manufacture, such as one utilizing a communication system may be tangibly embodied as or in the memory 710, which may be or comprise a device-readable storage medium.

The processing circuitry 702 may be configured to communicate with an access network or other network using the communication interface 712. The communication interface 712 may comprise one or more communication subsystems and may include or be communicatively coupled to an antenna 722. The communication interface 712 may include one or more transceivers used to communicate, such as by communicating with one or more remote transceivers of another device capable of wireless communication (e.g., another UE or a network node in an access network). Each transceiver may include a transmitter 718 and/or a receiver 720 appropriate to provide network communications (e.g., optical, electrical, frequency allocations, and so forth). Moreover, the transmitter 718 and receiver 720 may be coupled to one or more antennas (e.g., antenna 722) and may share circuit components, software or firmware, or alternatively be implemented separately.

In the illustrated embodiment, communication functions of the communication interface 712 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 712, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 700 shown in FIG. 7.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

### Network Node Per Some Embodiments

FIG. 8 illustrates a network node 800 per some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 800 includes a processing circuitry 802, a memory 804, a communication interface 806, and a power source 808. The network node 800 may be composed of multiple physically separate components (e.g., a NodeB component and a RNC component, or a BTS component and a BSC component, etc.), which may each have their own respective components. In certain scenarios in which the network node 800 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 800 may be configured to support multiple radio access technologies (RATs). In such embodiments, some components may be duplicated (e.g., separate memory 804 for different RATs) and some components may be reused (e.g., a same antenna 810 may be shared by different RATs). The network node 800 may also include multiple sets of the various illustrated components for different wireless technologies integrated into network node 800, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 800.

The processing circuitry 802 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 800 components, such as the memory 804, to provide network node 800 functionality.

In some embodiments, the processing circuitry 802 includes a system on a chip (SOC). In some embodiments, the processing circuitry 802 includes one or more of radio frequency (RF) transceiver circuitry 812 and baseband processing circuitry 814. In some embodiments, the radio frequency (RF) transceiver circuitry 812 and the baseband processing circuitry 814 may be on separate chips (or sets of chips), boards, or units, such as radio units and digital units. In alternative embodiments, part or all of RF transceiver circuitry 812 and baseband processing circuitry 814 may be on the same chip or set of chips, boards, or units.

The memory 804 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 802. The memory 804 may store any suitable instructions, data, or information, including a computer program, software, an application including one or more of logic, rules, code, tables, and/or other instructions capable of being executed by the processing circuitry 802 and utilized by the network node 800. The memory 804 may be used to store any calculations made by the processing circuitry 802 and/or any data received via the communication interface 806. In some embodiments, the processing circuitry 802 and memory 804 is integrated.

The communication interface 806 is used in wired or wireless communication of signaling and/or data between a network node, access network, and/or UE. As illustrated, the communication interface 806 comprises port(s)/terminal(s) 816 to send and receive data, for example to and from a network over a wired connection. The communication interface 806 also includes radio front-end circuitry 818 that may be coupled to, or in certain embodiments a part of, the antenna 810. Radio front-end circuitry 818 comprises filters 820 and amplifiers 822. The radio front-end circuitry 818 may be connected to an antenna 810 and processing circuitry 802. The radio front-end circuitry may be configured to condition signals communicated between antenna 810 and processing circuitry 802. The radio front-end circuitry 818 may receive digital data that is to be sent out to other network nodes or UEs via a wireless connection. The radio front-end circuitry 818 may convert the digital data into a radio signal having the appropriate channel and bandwidth parameters using a combination of filters 820 and/or amplifiers 822. The radio signal may then be transmitted via the antenna 810. Similarly, when receiving data, the antenna 810 may collect radio signals which are then converted into digital data by the radio front-end circuitry 818. The digital data may be passed to the processing circuitry 802. In other embodiments, the communication interface may comprise different components and/or different combinations of components.

In certain alternative embodiments, the network node 800 does not include separate radio front-end circuitry 818, instead, the processing circuitry 802 includes radio front-end circuitry and is connected to the antenna 810. Similarly, in some embodiments, all or some of the RF transceiver circuitry 812 is part of the communication interface 806. In still other embodiments, the communication interface 806 includes one or more ports or terminals 816, the radio front-end circuitry 818, and the RF transceiver circuitry 812, as part of a radio unit (not shown), and the communication interface 806 communicates with the baseband processing circuitry 814, which is part of a digital unit (not shown).

The antenna 810 may include one or more antennas, or antenna arrays, configured to send and/or receive wireless signals. The antenna 810 may be coupled to the radio front-end circuitry 818 and may be any type of antenna capable of transmitting and receiving data and/or signals wirelessly. In certain embodiments, the antenna 810 is separate from the network node 800 and connectable to the network node 800 through an interface or port.

The antenna 810, communication interface 806, and/or the processing circuitry 802 may be configured to perform any receiving operations and/or certain obtaining operations described herein as being performed by the network node. Any information, data and/or signals may be received from a UE, another network node and/or any other network equipment. Similarly, the antenna 810, the communication interface 806, and/or the processing circuitry 802 may be configured to perform any transmitting operations described herein as being performed by the network node. Any information, data and/or signals may be transmitted to a UE, another network node and/or any other network equipment.

The power source 808 provides power to the various components of network node 800 in a form suitable for the respective components (e.g., at a voltage and current level needed for each respective component). The power source 808 may further comprise, or be coupled to, power management circuitry to supply the components of the network node 800 with power for performing the functionality described herein. For example, the network node 800 may be connectable to an external power source (e.g., the power grid, an electricity outlet) via an input circuitry or interface such as an electrical cable, whereby the external power source supplies power to power circuitry of the power source 808. As a further example, the power source 808 may comprise a source of power in the form of a battery or battery pack which is connected to, or integrated in, power circuitry. The battery may provide backup power should the external power source fail.

Embodiments of the network node 800 may include additional components beyond those shown in FIG. 8 for providing certain aspects of the network node's functionality, including any of the functionality described herein and/or any functionality necessary to support the subject matter described herein. For example, the network node 800 may include user interface equipment to allow input of information into the network node 800 and to allow output of information from the network node 800. This may allow a user to perform diagnostic, maintenance, repair, and other administrative functions for the network node 800.

### Host Per Some Embodiments

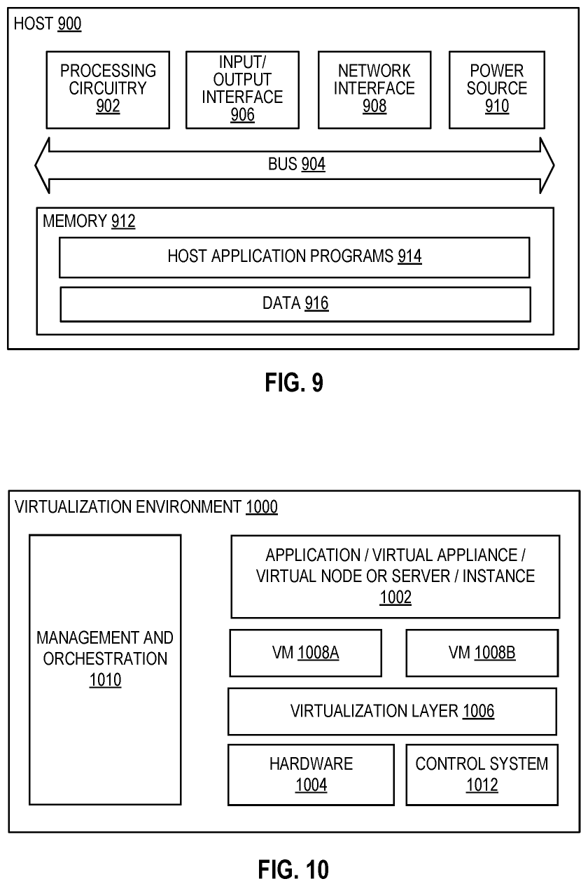

FIG. 9 is a block diagram of a host 900, which may be an embodiment of the host 616 of FIG. 6, per various aspects described herein. As used herein, the host 900 may be or comprise various combinations hardware and/or software, including a standalone server, a blade server, a cloud-implemented server, a distributed server, a virtual machine, container, or processing resources in a server farm. The host 900 may provide one or more services to one or more UEs.

The host 900 includes processing circuitry 902 that is operatively coupled via a bus 904 to an input/output interface 906, a network interface 908, a power source 910, and a memory 912. Other components may be included in other embodiments. Features of these components may be substantially similar to those described with respect to the devices of previous figures, such as FIGS. 7 and 8, such that the descriptions thereof are generally applicable to the corresponding components of host 900.

The memory 912 may include one or more computer programs including one or more host application programs 914 and data 916, which may include user data, e.g., data generated by a UE for the host 900 or data generated by the host 900 for a UE. Embodiments of the host 900 may utilize only a subset or all of the components shown. The host application programs 914 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 914 may also provide for user authentication and licensing checks and may periodically report health, routes, and content availability to a central node, such as a device in or on the edge of a core network. Accordingly, the host 900 may select and/or indicate a different host for over-the-top services for a UE. The host application programs 914 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

### Virtualization Environment Per Some Embodiments

FIG. 10 is a block diagram illustrating a virtualization environment 1000 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1002 (which may alternatively be called software instances, virtual appliances, network functions, virtual nodes, virtual network functions, etc.) are run in the virtualization environment 1000 to implement some of the features, functions, and/or benefits of some of the embodiments disclosed herein.

Hardware 1004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1006 (also referred to as hypervisors or virtual machine monitors (VMMs)), provide VMs 1008a and 1008b (one or more of which may be generally referred to as VMs 1008), and/or perform any of the functions, features and/or benefits described in relation with some embodiments described herein. The virtualization layer 1006 may present a virtual operating platform that appears like networking hardware to the VMs 1008.

The VMs 1008 comprise virtual processing, virtual memory, virtual networking or interface and virtual storage, and may be run by a corresponding virtualization layer 1006. Different embodiments of the instance of a virtual appliance 1002 may be implemented on one or more of VMs 1008, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1008 may be a software implementation of a physical machine that runs programs as if they were executing on a physical, non-virtualized machine. Each of the VMs 1008, and that part of hardware 1004 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1008 on top of the hardware 1004 and corresponds to the application 1002.

Hardware 1004 may be implemented in a standalone network node with generic or specific components. Hardware 1004 may implement some functions via virtualization. Alternatively, hardware 1004 may be part of a larger cluster of hardware (e.g., such as in a data center or CPE) where many hardware nodes work together and are managed via management and orchestration 1010, which, among others, oversees lifecycle management of applications 1002. In some embodiments, hardware 1004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1012 which may alternatively be used for communication between hardware nodes and radio units.

### Communication Among Host, Network Node, and UE Per Some Embodiments

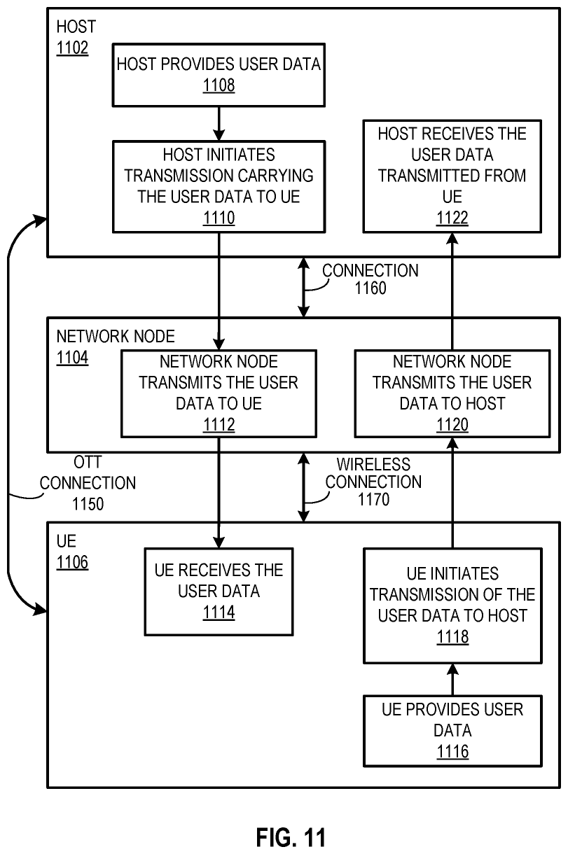

FIG. 11 illustrates a communication diagram of a host 1102 communicating via a network node 1104 with a UE 1106 over a partially wireless connection per some embodiments. Example implementations, in accordance with various embodiments, of the UE (such as a UE 612a of FIG. 6 and/or UE 700 of FIG. 7), network node (such as network node 610a of FIG. 6 and/or network node 800 of FIG. 8), and host (such as host 616 of FIG. 6 and/or host 900 of FIG. 9) discussed in the preceding paragraphs will now be described with reference to FIG. 11.

Like host 900, embodiments of host 1102 include hardware, such as a communication interface, processing circuitry, and memory. The host 1102 also includes software, which is stored in or accessible by the host 1102 and executable by the processing circuitry. The software includes a host application that may be operable to provide a service to a remote user, such as the UE 1106 connecting via an over-the-top (OTT) connection 1150 extending between the UE 1106 and host 1102. In providing the service to the remote user, a host application may provide user data which is transmitted using the OTT connection 1150.

The network node 1104 includes hardware enabling it to communicate with the host 1102 and UE 1106. The connection 1160 may be direct or pass through a core network (like core network 606 of FIG. 6) and/or one or more other intermediate networks, such as one or more public, private, or hosted networks. For example, an intermediate network may be a backbone network or the Internet.

The UE 1106 includes hardware and software, which is stored in or accessible by UE 1106 and executable by the UE's processing circuitry. The software includes a client application, such as a web browser or operator-specific “app” that may be operable to provide a service to a human or non-human user via UE 1106 with the support of the host 1102. In the host 1102, an executing host application may communicate with the executing client application via the OTT connection 1150 terminating at the UE 1106 and host 1102. In providing the service to the user, the UE's client application may receive request data from the host's host application and provide user data in response to the request data. The OTT connection 1150 may transfer both the request data and the user data. The UE's client application may interact with the user to generate the user data that it provides to the host application through the OTT connection 1150.

The OTT connection 1150 may extend via a connection 1160 between the host 1102 and the network node 1104 and via a wireless connection 1170 between the network node 1104 and the UE 1106 to provide the connection between the host 1102 and the UE 1106. The connection 1160 and wireless connection 1170, over which the OTT connection 1150 may be provided, have been drawn abstractly to illustrate the communication between the host 1102 and the UE 1106 via the network node 1104, without explicit reference to any intermediary devices and the precise routing of messages via these devices.

As an example of transmitting data via the OTT connection 1150, in step 1108, the host 1102 provides user data, which may be performed by executing a host application. In some embodiments, the user data is associated with a particular human user interacting with the UE 1106. In other embodiments, the user data is associated with a UE 1106 that shares data with the host 1102 without explicit human interaction. In step 1110, the host 1102 initiates a transmission carrying the user data towards the UE 1106. The host 1102 may initiate the transmission responsive to a request transmitted by the UE 1106. The request may be caused by human interaction with the UE 1106 or by operation of the client application executing on the UE 1106. The transmission may pass via the network node 1104, in accordance with the teachings of the embodiments described throughout this disclosure. Accordingly, in step 1112, the network node 1104 transmits to the UE 1106 the user data that was carried in the transmission that the host 1102 initiated, in accordance with the teachings of the embodiments described throughout this disclosure. In step 1114, the UE 1106 receives the user data carried in the transmission, which may be performed by a client application executed on the UE 1106 associated with the host application executed by the host 1102.

In some examples, the UE 1106 executes a client application which provides user data to the host 1102. The user data may be provided in reaction or response to the data received from the host 1102. Accordingly, in step 1116, the UE 1106 may provide user data, which may be performed by executing the client application. In providing the user data, the client application may further consider user input received from the user via an input/output interface of the UE 1106. Regardless of the specific manner in which the user data was provided, the UE 1106 initiates, in step 1118, transmission of the user data towards the host 1102 via the network node 1104. In step 1120, in accordance with the teachings of the embodiments described throughout this disclosure, the network node 1104 receives user data from the UE 1106 and initiates transmission of the received user data towards the host 1102. In step 1122, the host 1102 receives the user data carried in the transmission initiated by the UE 1106.

### Terms

References in the specification to “one embodiment,” “an embodiment,” “an example embodiment,” and so forth, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The description and claims may use the terms “coupled” and “connected,” along with their derivatives. These terms are not intended as synonyms for each other. “Coupled” is used to indicate that two or more elements, which may or may not be in direct physical or electrical contact with each other, co-operate or interact with each other. “Connected” is used to indicate the establishment of wireless or wireline communication between two or more elements that are coupled with each other.

An electronic device (such as the electronic device 502) stores and transmits (internally and/or with other electronic devices over a network) code (which is composed of software instructions and which is sometimes referred to as a computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical, or other form of propagated signals—such as carrier waves, infrared signals). Thus, an electronic device (e.g., a computer) includes hardware and software, such as a set of one or more processors (e.g., of which a processor is a microprocessor, controller, microcontroller, central processing unit, digital signal processor, application specific integrated circuit (ASIC), field programmable gate array (FPGA), other electronic circuitry, or a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed). When the electronic device is turned on, that part of the code that is to be executed by the processor(s) of the electronic device is typically copied from the slower non-volatile memory into volatile memory (e.g., dynamic random-access memory (DRAM), static random-access memory (SRAM)) of the electronic device. Typical electronic devices also include a set of one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of (1) receiving data from other electronic devices over a wireless connection and/or (2) sending data out to other devices through a wireless connection. This radio circuitry may include transmitter(s), receiver(s), and/or transceiver(s) suitable for radio frequency communication. The radio circuitry may convert digital data into a radio signal having the proper parameters (e.g., frequency, timing, channel, bandwidth, and so forth). The radio signal may then be transmitted through antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate with wire through plugging in a cable to a physical port connected to an NIC. One or more parts of an embodiment of the invention may be implemented using different combinations of software, firmware, and/or hardware.

The terms “module,” “logic,” and “unit” used in the present application, may refer to a circuit for performing the function specified. In some embodiments, the function specified may be performed by a circuit in combination with software such as by software executed by a general-purpose processor.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices, and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

1. A method to be implemented in a network node of a network, the method comprising:
receiving a message indicating scheduling information of an application;
upon a scheduling scheme being feasible to deploy the application in the network, determining the scheduling scheme based on the scheduling information of the application, the scheduling scheme accommodating the application and constraints of one or more network nodes in the network;
applying the scheduling scheme in the network upon the scheduling scheme being acceptable by one or more parties outside of the network and involved in deploying the application; and
causing data of the application from the one or more parties outside of the network to be processed in the network based on the scheduling scheme, wherein processing the data includes pre-fetching information from the one or more parties outside of the network prior to receiving the data of the application.

2. The method of claim 1, wherein the scheduling information of the application is derived from scheduling parameters of the application, wherein the scheduling parameters indicate one or more of:
how long one or more tasks of the application are to be ran in one instance,
a periodic duration in which the one or more tasks of the application are to be ran,
a deadline of executing the one or more tasks of the application, and
a priority of the one or more tasks.

3. The method of claim 1, wherein the scheduling information of the application is provided by a periodic timer upon one or more corresponding tasks of the application being driven by a timer.

4. The method of claim 1, wherein the scheduling information of the application is derived based on a pattern of the data of the application at the one or more parties outside of the network and involved in deploying the application.

5. The method of claim 1, wherein the scheduling information of the application specifies upon the application sending data to the network node.

6. The method of claim 1, the method further comprising:
sending a response to the message upon determining whether the scheduling scheme is feasible to deploy the application in the network.

7. The method of claim 6, wherein upon no scheduling scheme being feasible to deploy the application in the network, the response indicates one or more requirements of the application that the network cannot meet.

8. The method of claim 1, wherein the scheduling scheme is deemed to be acceptable by the one or more parties outside of the network and involved in deploying the application upon a confirmation being received from the one or more parties outside of the network about the scheduling scheme.

9. The method of claim 8, wherein the one or more parties outside of the network transmits the confirmation upon the one or more parties outside of the network receiving the scheduling scheme from the network node.

10. The method of claim 1, wherein applying the scheduling scheme comprises setting up one or more triggers to allocation resources prior to getting the data of the application from the one or more parties outside of the network.

11. The method of claim 1, wherein applying the scheduling scheme comprises reducing power consumption of the network node prior to getting the data from the one or more parties outside of the network.

12. The method of claim 1, wherein processing data from the one or more parties outside of the network based on the scheduling scheme comprises maintaining data from the one or more parties outside of the network in a cache upon the scheduling information of the application indicating that occurrence of the application is over a threshold.

13. The method of claim 1, wherein a user plane function (UPF) determines the scheduling scheme based on the scheduling information of the application.

14. The method of claim 13, wherein the message indicating scheduling information of the application is received by the UPF through a network exposure function (NEF) and a session management function (SMF).

15. An electronic device, comprising:
a processor and non-transitory machine-readable storage medium that provides instructions that, when executed by the processor, are capable of causing the processor to perform operations of:
receiving a message indicating scheduling information of an application;
upon a scheduling scheme being feasible to deploy the application in a network, determining the scheduling scheme based on the scheduling information of the application, the scheduling scheme accommodating the application and constraints of one or more network nodes in the network;
applying the scheduling scheme in the network upon the scheduling scheme being acceptable by one or more parties outside of the network involved in deploying the application; and
causing data of the application from the one or more parties outside of the network to be processed in the network based on the scheduling scheme, wherein processing the data includes pre-fetching information from the one or more parties outside of the network prior to receiving the data of the application.

16. The electronic device of claim 15, wherein the scheduling information of the application is derived from scheduling parameters of the application, wherein the scheduling parameters indicate one or more of:
how long one or more tasks of the application are to be ran in one instance,
a periodic duration in which the one or more tasks of the application are to be ran,
a deadline of executing the one or more tasks of the application, and
a priority of the one or more tasks.

17.-19. (canceled)

20. The electronic device of claim 15, the operations further comprising:
sending a response to the message upon determining whether the scheduling scheme is feasible to deploy the application in the network.

21.-26. (canceled)

27. The electronic device of claim 15, wherein a user plane function (UPF) determines the scheduling scheme based on the scheduling information of the application.

28. The electronic device of claim 27, wherein the message indicating scheduling information of the application is received by the UPF through a network exposure function (NEF) and a session management function (SMF).

29. A non-transitory machine-readable storage medium that provides instructions that, when executed by a processor, are capable of causing the processor to perform:
receiving a message indicating scheduling information of an application;
upon a scheduling scheme being feasible to deploy the application in a network, determining the scheduling scheme based on the scheduling information of the application, the scheduling scheme accommodating the application and constraints of one or more network nodes in the network;
applying the scheduling scheme in the network upon the scheduling scheme being acceptable by one or more parties outside of the network and involved in deploying the application; and
causing data of the application from the one or more parties outside of the network to be processed in the network based on the scheduling scheme, wherein processing the data includes pre-fetching information from the one or more parties outside of the network prior to receiving the data of the application.

30. (canceled)
